(19) United States
(12) Patent Application Publication
(10) Pub. No.: US 2009/0273745 A1
(43) Pub. Date: Nov. 5, 2009

(54) Color filter and liquid crystal display panel using the same

(75) Inventors: Yun-I Liu, Hsin-Chu (TW); Sheng-Wen Cheng, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: AU OPTRONICS CORP., Hsin-Chu (TW)

(21) Appl. No.: 12/213,890

(22) Filed: Jun. 26, 2008

(30) Foreign Application Priority Data
May 2, 2008 (TW) 97116335

(51) Int. Cl. G02F 1/1335; G02B 5/20

(52) U.S. Cl. 349/106; 359/891

(57) ABSTRACT

A color filter including a substrate, a black matrix and a plurality of color filter films is provided. The black matrix is disposed on the substrate and the black matrix has a plurality of openings. The black matrix has a bottom surface contacting with the substrate and a top surface having an area equal to that of the bottom surface. Besides, a plurality of color filter films are disposed on the substrate exposed by the openings respectively and each of the color filter films has a flat top surface. In the above mentioned color filter, coincidence between the black matrix and the color filter films is excellent.

This application claims the benefit of Taiwan Patent Application Serial No. 97116335, filed May 2, 2008, the subject matter of which is incorporated herein by reference.

### BACKGROUND OF THE INVENTION

1. Field of the Invention

The present invention generally relates to a color filter and a liquid crystal display panel using the same, and especially relates to a color filter having better color gamut and a liquid crystal display panel using the same.

2. Description of Related Art

Recently, a method of manufacturing a color filter using inkjet printing is developed. For this specific method, first, forming a black matrix having a plurality of openings on a substrate. Second, conducting inkjet printing to jetting the color materials (red, green or blue) in the openings of the black matrix. Finally, conducting a thermal baking process to harden the color materials so that the color filter is formed. However, disadvantage(s) of the method mentioned above still occurs. Fro example, during the inkjet printing process, while the color materials are jetted into the openings of the black matrix, because the speed of the jetting is fast, color materials may splash to cause some pollutions. Therefore, if the inkjet printing process is not controlled properly, undesired color materials mixture problems occur between adjacent openings may happen.

FIG. 1 is a schematic view showing the way to form hydrophobic film on the conventional black matrix by plasma containing fluorine. In FIG. 1, conventional color filter 100 comprises a substrate 110 and black matrix 112 disposed on the substrate 110. Black matrix 112 has openings P, and in FIG. 1, only an opening is shown for example. To prevent overflow or mixture of the color materials, hydrophobic process 120 is often conducted to the surface of the black matrix 112 to form hydrophobic film 130 containing fluorine. As shown in FIG. 1, plasma containing fluorine would react with the top surface 114 and the side surfaces 116 of the black matrix 112, so that the hydrophobic film 130 containing fluorine would be formed on the top surface 114 and the side surfaces 116 of the black matrix 112.

### SUMMARY OF THE INVENTION

Accordingly, the present invention is directed to provide a color filter to improve the coincidence between the black matrix and the color filter films.

The present invention is also directed to provide a liquid crystal display panel having better display color gamut.

The present invention provides a color filter. The color filter comprises a substrate, a partition formed on the substrate and color filter films. The partition has a plurality of openings, a bottom surface contacting with the substrate; and a top surface having an area equal to that of the bottom surface. The color filter films are disposed on the substrate which is exposed by the openings, respectively. At least one of the color filter films has a flat top surface. The partition has a cross-section shape of [symbol] .

In one of the embodiments of the present invention, the top surface of the partition is hydrophobic.

In one of the embodiments of the present invention, the color filter films include at least one red filter film, at least one green filter film and at least one blue filter film.

In one of the embodiments of the present invention, the partition further has a plurality of side surfaces contacting the colof filter films, wherein the side surfaces are hydrophilic.

In one of the embodiments of the present invention, the partition is comprised of photoresist, black matrix, metal, dry film or the combinations thereof.

In one of the embodiments of the present invention, the partition has a height of about 1 micrometer to 5 micrometers.

In one of the embodiments of the present invention, the openings have a width of about 50 micrometers to 300 micrometers, and the openings have a length of about 100 micrometers to 500 micrometers.

The present invention provides a liquid crystal display panel. The liquid crystal display panel comprises an array substrate, a color filter according to the at least of the above embodiments, and a liquid crystal. The color filter and the array substrate are disposed oppositely. The liquid crystal layer is disposed between the array substrate and the color filter.

In one of the embodiments of the present invention, the array substrate comprises a thin film transistor array substrate.

An objective of the present invention is to using a partition having a bottom surface contacting with the substrate; and a top surface having an area equal to that of the bottom surface to make the color materials be jetted into the openings completely and uniformly when manufacturing a color filter. Therefore, the color filter according to the present invention has the advantages of improving the color gamut of the conventional color filter and of preventing light leakage.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view showing the way to form hydrophobic film on the conventional black matrix by plasma containing fluorine.

FIG. 2 is top view of the color filter according the present invention.

FIG. 3A is partial cross-section view of the color filter according to the first embodiment of the present invention.

FIG. 3B is partial cross-section view of the color filter according to the second embodiment of the present invention.

FIG. 3C is partial cross-section view of the color filter according to the third embodiment of the present invention.

FIG. 3D is partial cross-section view of the color filter according to the fourth embodiment of the present invention.

FIG. 4 is schematic view of the liquid crystal display panel according to the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

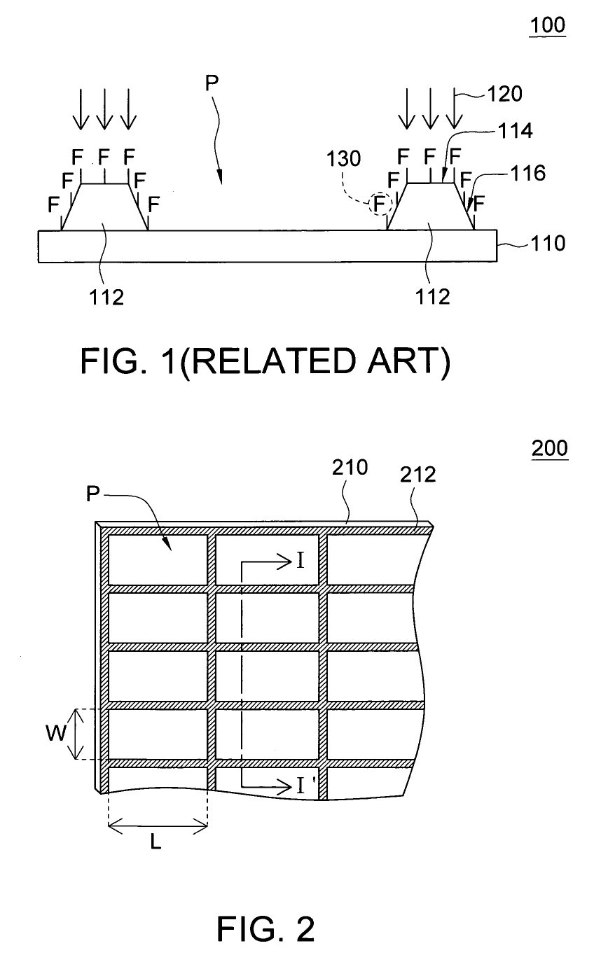

Considering conventional color filter 100 in FIG. 1, because black matrix 110's side surfaces 116 are hydrophobic, color materials and side surfaces 116 of the black matrix 112 are not coincidence when providing the coloe materials into the openings P, so that the coincidence between the color filter film and the black matrix 112 and bad color gamut of the color filter may happen.

As known in the conventional color filter, to prevent color materials from splashing, mixture or pollution when conducting inkjet printing to manufacturing the color filter, hydrophile treatment may be conducted to the black matrix which has island-shape. However, after the hydrophile treatment, hydrophile of the side surfaces may create that the color materials are not totally and completely filled in the openings of the black matrix. Furthermore, light leakage may happen at the edges of the black matrix.

Therefore, the present invention provides many designs of the color filter to solve the problems mentioned above.

FIG. 2 is top view of the color filter 200 according to the present invention. In FIG. 2, color filter 200 comprises partition disposed on the substrate 210 and many color filter films 230 disposed on the substrate exposed by the openings P, respectively or individually.

For example, partition is comprised of photoresist, black matrix, metal, dry film or the combinations thereof. In the embodiments of the present invention, black matrix 212 is taken for example, but not limited thereto. Openings P of the black matrix 212 has width W of about 50 micrometers to 300 micrometers, preferable, of about 100 micrometers to 200 micrometers. Openings P of the black matrix 212 have length L of about 100 micrometers to 500 micrometers, preferable, of about 350 micrometers to 450 micrometers. Openings P of the black matrix 212 have height of about 1 micrometer to 5 micrometers.

The partition has a cross-section shape of [symbol] for example.

The partition is comprised of resin material, for example. The resin material comprises photoresist containing binder and initiator. Binder comprises unsaturated vinyl double bond monomer (such as epoxy acrylate, urethane acrylate or polyester acrylate). Initial comprises trihalo trihalomethyl triazine compounds (such as2-(naphth-1-IRU)-4 of publication and 6-screw-halomethyl-s-triazine compound), oxime compound (such as (2-(O-benzoyl oxime)-1-[4-(phenylthio)phenyl]-1,2-octane dione, 1-(4-methylsulfanyl-phenyl)-Butane-1,2-butane 2-oxime-O-acetate), or alpha-amino ketone compound (such as Ciba-Geigy IRGACURE series 907: IRGACURE, IRGACURE 369 grade, etc.) Photo sensitivity of the resin material is wavelength of about 250 manometers to about 400 manometers. Thermal sensitivity of the resin material is about 80° C. to 230° C. The partition will have a structure of [symbol] because during exposing the partition, the surface of the partition has higher photo sensitivity and receives more light volume than the middle or lower portion thereof, and/or simultaneously, during providing pre-baked temperature of about 90° C. to 120° C. to the partition so that the attachment between the resin material and the substrate 210 is greater, therefore, cross-linked reaction of the upper portion of the partition is more complete than the lower portion thereof.

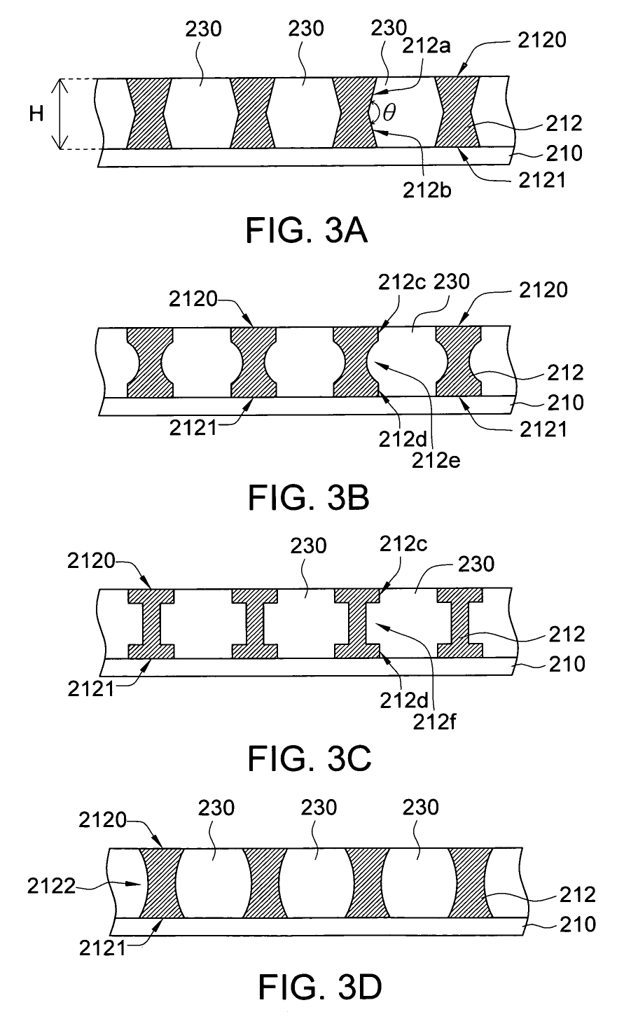

FIGS. 3A to 3D are partial cross view of color filter 200 according to the four embodiments respectively of the present invention along cross line I-I′ of FIG. 2.

### First Embodiment

FIG. 3A is partial cross view of color filter 200 according to the first embodiment of the present invention. Black matrix 212 has bottom surface 2121 contacting substrate 210, and top surface 2120 having an area equal to that of the bottom surface 2121. A plurality of color filter films 230 are disposed in the openings P, respectively or individually. At least one or each of the color filter films 230 has a flat upper surface.

In order to prevent or decrease the splash phenomena of the color materials in the inkjet printing process, present embodiment uses CF4 plasma SF6 plasma to the conduct hydrophobe treatment to the black matrix 212 so that the black matrix 212 is hydrophobic. For the color filter 200 in the present embodiment of the present invention, black matrix 212's top surface 2120 has an area equal to that of the bottom surface 2121, and substantially has a cross-section shape of [symbol] Specifically, in the present embodiment, black matrix 212 has a first side surface 212a and a second side surface 212b. The first side surface 212a and the second side surface 212b form an angle θ of about 120° to 160°. Such that, when conducting hydrophobe treatment to the top surface 2120 of the black matrix 212 by using plasma containing fluorine, plasma containing fluorine may only have effect to the top surface 2120 of the black matrix 212 so that the top surface 2120 is hydrophobic. That is to say, other surfaces except the top surface 2120 of the black matrix 212 does not have significant hydrophobe. In other words, side surfaces 212a, 212b contacting the color filter films 230 are hydrophilic. Color materials for inkjet printing comprise pigment, dye or the combination thereof.

Because the black matrix 212 has a cross-section shape substantially of [symbol] which is specific, the color filter films 230 have a flat top surface. Furthermore, because top and bottom widths of the black matrix 212 is greater then middle width thereof, light linkage can be prevent more.

### Second Embodiment

FIG. 3B is partial cross view of color filter 200 according to the second embodiment of the present invention. Objects, function and operation principle of the color filter 200 according to the present embodiment is similar to that according to the first embodiment. However, unlike the first embodiment, black matrix 212 of the present embodiment has another design, specifically, has another cross-section shape.

In FIG. 3B, black matrix 212 has a cross-section shape substantially of [symbol] Black matrix 212 has a bottom surface 2121 contacting the substrate 210, and a top surface 2120 having a area equal to that of the bottom surface 2121. A plurality of color filter films 230 are disposed in the openings P individually or respectively. At least one or each of the color films 230 has a flat top surface.

Black matrix 212 has side surfaces 212c, 212d and 212e. Side surface 212c and 212d are respectively perpendicular to the top surface 212c and 212d. Side surface 212e substantially has a shape of curve and is between the side surfaces 212c and 212d.

### Third Embodiment

FIG. 3C is partial cross view of color filter 200 according to the third embodiment of the present invention. Objects, function and operation principle of the color filter 200 according to the present embodiment is similar to that according to the first embodiment. However, unlike the first embodiment, black matrix 212 of the present embodiment has another design, specifically, has another cross-section shape.

In FIG. 3C, black matrix 212 has a cross-section shape compactly of [symbol] Black matrix 212 has a bottom surface 2121 contacting the substrate 210, and a top surface 2120 having a area equal to that of the bottom surface 2121. A plurality of color filter films 230 are disposed in the openings P individually or respectively. At least one or each of the color films 230 has a flat top surface.

Black matrix 212 has side surfaces 212c, 212d and 212e. Side surface 212c and 212d are respectively perpendicular to the top surface 212c and 212d. Side surface 212f is between the side surfaces 212c and 212d.

### Fourth Embodiment

FIG. 3D is partial cross view of color filter 200 according to the fourth embodiment of the present invention. Objects, function and operation principle of the color filter 200 according to the present embodiment is similar to that according to the first embodiment. However, unlike the first embodiment, black matrix 212 of the present embodiment has another design, specifically, has another cross-section shape.

In FIG. 3D, black matrix 212 has a cross-section shape substantially of [symbol] Black matrix 212 has a bottom surface 2121 contacting the substrate 210, and a top surface 2120 having a area equal to that of the bottom surface 2121. A plurality of color filter films 230 are disposed in the openings P individually or respectively. At least one or each of the color films 230 has a flat top surface.

Black matrix 212 has side surfaces 2122 directly connecting with both of top surfaces 2120 and bottom surface 2121. Side surfaces 2122 have a shape of curve.

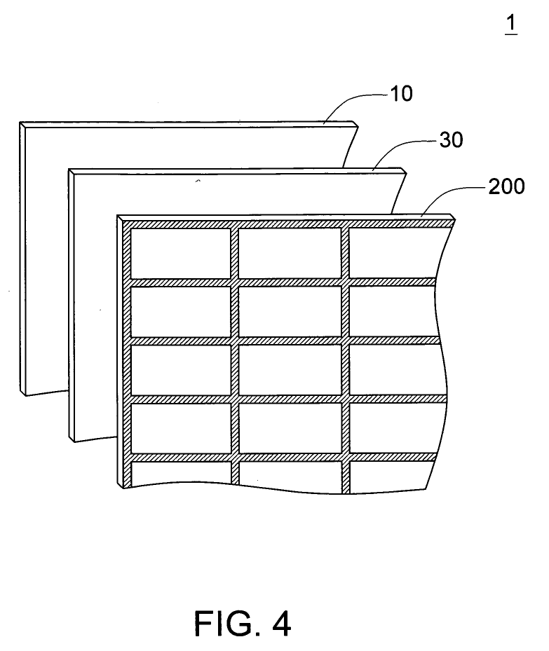

FIG. 4 is schematic view of the liquid crystal display panel according to the embodiments of the present invention. In FIG. 4, liquid crystal display panel 1 comprises array substrate 10, color filter 200 and liquid crystal layer 30. Color filter 200 and array substrate 10 are disposed oppositely. Liquid crystal layer 30 is disposed between the array substrate 10 and the color filter 200. Specifically, color filter 200 is used any one color filter of the above embodiments. As a result, liquid crystal display panel 1 can have better display color gamut and leakage phenomena may not easily occur.

As mentioned above, the present invention uses a black matrix having a unique or same area of the top surface and the bottom surface, as said structure of [symbol] Therefore, after conducting hydrophobe treatment, top surface of the black matrix has significant hydrophobe. When providing color materials into the openings of the black matrix, the phenomena of that color materials can not uniformly be filled therein would not happen. As a result, color filter according to the present invention has better color gamut and leakage phenomena may not easily occur even the light is emitted from the bottom or from the top.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color filter, comprising:
a substrate;
a partition disposed on the substrate, wherein the partition has:
a plurality of openings;
a bottom surface contacting with the substrate; and
a top surface having an area equal to that of the bottom surface; and
a plurality of color filter films disposed in the openings, respectively.

2. The color filter according to claim 1, wherein the top surface of the partition is hydrophobic.

3. The color filter according to claim 1, wherein at least one of the color filter films has a flat top surface.

4. The color filter according to claim 1, wherein the color filter films include at least one red filter film, at least one green filter film and at least one blue filter film.

5. The color filter according to claim 1, wherein the partition further has a plurality of side surfaces contacting the colof filter films, wherein the side surfaces are hydrophilic.

6. The color filter according to claim 1, wherein the partition is comprised of photoresist, black matrix, metal, dry film or the combinations thereof.

7. The color filter according to claim 1, wherein the partition has a height of about 1 micrometers to 5 micrometers.

8. The color filter according to claim 1, wherein the openings have a width of about 50 micrometers to 300 micrometers.

9. The color filter according to claim 8, wherein the openings have a length of about 100 micrometers to 500 micrometers.

10. The color filter according to claim 1, wherein the openings have a length of about 100 micrometers to 500 micrometers.

11. The color filter according to claim 1, wherein the openings have a length of about 350 micrometers to 450 micrometers.

12. The color filter according to claim 1, wherein the partition has a cross-section shape of

[symbol]

13. A liquid crystal display panel, comprising:
an array substrate;
a color filter disposed opposite to the array substrate, comprising:
a substrate;
a partition disposed on the substrate, wherein the partition has:
a plurality of openings;
a bottom surface contacting with the substrate; and
a top surface having an area equal to that of the bottom surface; and
a plurality of color filter films disposed in the openings, respectively; and
a liquid crystal layer disposed between the array substrate and the color filter.

14. The liquid crystal display panel according to claim 13, wherein the array substrate comprises a thin film transistor array substrate.

15. The liquid crystal display panel according to claim 13, wherein the partition has a cross-section shape of [symbol]
